(19) United States
(12) Patent Application Publication
(10) Pub. No.: US 2025/0358147 A1
(43) Pub. Date: Nov. 20, 2025

(54) VEHICLE-MOUNTED CONTROL DEVICE, CONTROL METHOD, AND CONTROL PROGRAM

(71) Applicants: AutoNetworks Technologies, Ltd., Yokkaichi-Shi, Mie (JP); Sumitomo Wiring Systems, Ltd., Yokkaichi-Shi, Mie (JP); Sumitomo Electric Industries, Ltd., Osaka-Shi, Osaka (JP)

(72) Inventor: Masahiro ENDO, Yokkaichi-Shi, Mie (JP)

(73) Assignees: AutoNetworks Technologies, Ltd., Yokkaichi-Shi, Mie (JP); Sumitomo Wiring Systems, Ltd., Yokkaichi-Shi, Mie (JP); Sumitomo Electric Industries, Ltd., Osaka-Shi, Osaka (JP)

(21) Appl. No.: 18/854,827

(22) PCT Filed: Mar. 28, 2023
(86) PCT No.: PCT/JP2023/012472

§ 371 Date: Oct. 7, 2024

(30) Foreign Application Priority Data
Apr. 8, 2022 (JP) 2022-064471

(51) Int. Cl. H04L 12/46; H04L 12/12; H04W 4/46

(52) U.S. Cl. CPC H04L 12/46; H04L 12/12; H04W 4/46

(57) ABSTRACT

A vehicle-mounted control device includes: a first processing unit configured to execute relay processing for relaying a message to be communicated between a plurality of vehicle-mounted devices; a second processing unit configured to execute vehicle-related processing different from the relay processing; and a determination unit configured to dynamically determine a first period for executing the relay processing to be executed by the first processing unit and a second period for executing the processing to be executed by the second processing unit.

### CROSS-REFERENCE TO RELATED APPLICATIONS

This application is the U.S. national stage of PCT/JP2023/012472 filed on Mar. 28, 2023, which claims priority of Japanese Patent Application No. JP 2022-064471 filed on Apr. 8, 2022, the contents of which are incorporated herein.

### TECHNICAL FIELD

The present disclosure relates to a vehicle-mounted control device, a control method, and a control program.

### BACKGROUND

A vehicle is equipped with a variety of vehicle-mounted devices, such as a control-system ECU (Electronic Control Unit) that controls an engine, a transmission, and the like, a body-system ECU that controls headlights, power windows, and the like, and an information-system ECU for a navigation device, a multimedia device, and the like. In recent years, it has been proposed that a plurality of virtual machines are constructed in a single vehicle-mounted device and provide the functions of a plurality of ECUs. If the plurality of virtual machines are run in one vehicle-mounted device, task execution time is allocated to each virtual machine in a time-sharing manner. JP 2012-185531A discloses changing the execution time of tasks assigned to each virtual machine, depending on the position of an ignition switch and the state of the engine (ACC OFF, ACC ON, immediately after IG OFF, immediately after IG ON, IG ON steady state).

A vehicle-mounted device includes a relay device that relays communication between a plurality of vehicle-mounted devices. When implementing such a relay device using a virtual machine, relay processing cannot be performed efficiently unless task execution time is allocated to a period during which a message is received from the vehicle-mounted device.

### SUMMARY

A vehicle-mounted control device according to an aspect of the present disclosure includes: a first processing unit configured to execute relay processing for relaying a message to be communicated between a plurality of vehicle-mounted devices; a second processing unit configured to execute vehicle-related processing different from the relay processing; and a determination unit configured to dynamically determine a first period for executing the relay processing to be executed by the first processing unit and a second period for executing the processing to be executed by the second processing unit.

A control method according to an aspect of the present disclosure includes: a step of executing relay processing for relaying a message to be communicated between a plurality of vehicle-mounted devices; a step of executing vehicle-related processing different from the relay processing; and a step of dynamically determining a first period for executing the relay processing and a second period for executing the processing different from the relay processing.

A control program according to an aspect of the present disclosure is a control program to be used in a vehicle-mounted control device configured to execute relay processing for relaying a message to be communicated between a plurality of vehicle-mounted devices and vehicle-related processing different from the relay processing, the control program being for causing a computer to function as a determination unit configured to dynamically determine a first period for executing the relay processing and a second period for executing the processing different from the relay processing.

The present disclosure can not only be realized as a vehicle-mounted control device having the above-described characteristic configuration, a control method having steps corresponding to characteristic processing in the vehicle-mounted control device, and a control program for causing the vehicle-mounted control device to execute the characteristic processing, but also as a vehicle-mounted system including the vehicle-mounted control device, and some or all of the vehicle-mounted control device can be realized as a semiconductor integrated circuit.

### Advantageous Effects

According to the present disclosure, in a vehicle-mounted control device that performs relay processing for relaying messages to be communicated between a plurality of vehicle-mounted devices and vehicle-related processing different from the relay processing, a first period for executing the relay processing and a second period for executing the processing different from the relay processing can be appropriately determined.

### BRIEF DESCRIPTION OF DRAWINGS

FIG. 1 is a block diagram showing an example of a configuration of a vehicle-mounted system according to an embodiment.

FIG. 2 is a block diagram showing an example of a configuration of an integrated ECU according to the embodiment.

FIG. 3 is a schematic diagram for describing a virtual environment in an integrated ECU according to the embodiment.

FIG. 4 is a functional block diagram showing an example of functions of the integrated ECU according to the embodiment.

FIG. 5A is a timing chart showing an example of a relationship between a first period, a second period, and reception timing of a message.

FIG. 5B is a diagram for describing determination of the first period and the second period by the integrated ECU according to the embodiment.

FIG. 6 is a diagram for describing an example of detection of a phase change in message communication.

FIG. 7 is a flowchart showing an example of period determination processing performed by an integrated ECU according to the embodiment.

FIG. 8 is a functional block diagram showing a modified example of the functions of the integrated ECU according to the embodiment.

### DETAILED DESCRIPTION OF PREFERRED EMBODIMENTS

Hereinafter, an overview of embodiments of the present disclosure will be listed and described.

In a first aspect, a vehicle-mounted control device according to the present embodiment includes: a first processing unit configured to execute relay processing for relaying a message to be communicated between a plurality of vehicle-mounted devices; a second processing unit configured to execute vehicle-related processing different from the relay processing; and a determination unit configured to dynamically determine a first period for executing the relay processing to be executed by the first processing unit and a second period for executing the processing to be executed by the second processing unit. This makes it possible to appropriately determine the first period for executing the relay processing and the second period for executing the processing different from the relay processing.

In a second aspect according to the first aspect, the message may be cyclically communicated between the plurality of vehicle-mounted devices, and the determination unit may determine the first period based on a cycle of the message. This makes it possible to allocate the first period to a period during which the message can be received.

In a third aspect according to the second aspect, the determination unit may determine the first period based on a probability distribution of receiving the message over time. This makes it possible to allocate the first period to a period during which the probability of receiving the message is high.

In a fourth aspect according to the third aspect, the determination unit may determine the first period based on a comparison between the probability distribution and a threshold value. This makes it possible to use a threshold value to determine a period during which the probability of receiving the message is high.

In a fifth aspect according to the third or the fourth aspects, the vehicle-mounted control device may include a creation unit configured to create the probability distribution. This makes it possible to determine the first period using the probability distribution created in the vehicle-mounted control device.

In a sixth aspect according to the fifth aspect, the creation unit may create the probability distribution based on a reception history of the message in the vehicle-mounted control device. This makes it possible to use the message reception history to obtain a probability distribution that reflects the reception cycle of the message.

In a seventh aspect according to the sixth aspect, the vehicle-mounted control device may include a phase change detection unit configured to detect a change in a phase of cyclical communication of the message, and the creation unit may create the probability distribution based on the reception history of the message after the change in the phase detected by the phase change detection unit. This makes it possible to obtain a probability distribution that reflects the reception cycle of the message after the phase of the communication changes.

In an eighth aspect according to the third or the fourth aspects, the determination unit may determine the first period based on the probability distribution created by an external device provided outside of the vehicle. This eliminates the need to create the probability distribution in the vehicle-mounted control device. The vehicle-mounted control device can determine the first period using the probability distribution created in the external device.

In a ninth aspect according to any of the first through the eighth aspects, the determination unit may determine the first period and the second period at a timing based on a fixed cycle including the first period and the second period. This makes it possible to determine the first period and the second period at an appropriate timing.

In a tenth aspect according to any of the first through the ninth aspects, the vehicle-mounted control device may include a state change detection unit configured to detect a change in a state of the vehicle, and the determination unit may determine the first period and the second period when a change in the state is detected by the state change detection unit. This makes it possible to determine the first period and the second period at an appropriate timing.

In an eleventh aspect according to the tenth aspect, the change in the state of the vehicle may include a change in a traveling state of the vehicle. This makes it possible to determine the first period and the second period at the timing when the traveling state of the vehicle changes.

In a twelfth aspect according to the tenth aspect, the change in the state of the vehicle may include a change in a configuration of a vehicle-mounted network including the plurality of vehicle-mounted devices. This makes it possible to determine the first period and the second period at the timing when the configuration of the vehicle-mounted network changes.

In a thirteenth aspect according to the tenth aspect, the change in the state of the vehicle may include at least one of the plurality of vehicle-mounted devices switching from a normal running state to a sleep state, or from the sleep state to the normal running state. This makes it possible to determine the first period and the second period at the timing when the state of the vehicle-mounted device changes between the normal running state and the sleep state.

A control method according to the present embodiment includes: a step of executing relay processing for relaying a message to be communicated between a plurality of vehicle-mounted devices; a step of executing vehicle-related processing different from the relay processing; and a step of dynamically determining a first period for executing the relay processing and a second period for executing the processing different from the relay processing. This makes it possible to appropriately determine the first period for executing the relay processing and the second period for executing the processing different from the relay processing.

A control program according to the present embodiment is a control program to be used in a vehicle-mounted control device configured to execute relay processing for relaying a message to be communicated between a plurality of vehicle-mounted devices and vehicle-related processing different from the relay processing, the control program being for causing a computer to function as a determination unit configured to dynamically determine a first period for executing the relay processing and a second period for executing the processing different from the relay processing. This makes it possible to appropriately determine the first period for executing the relay processing and the second period for executing the processing different from the relay processing.

Hereinafter, details of embodiments of the present disclosure will be described with reference to the drawings. Note that at least some of the embodiments described below may be combined as appropriate.

### Vehicle-Mounted System

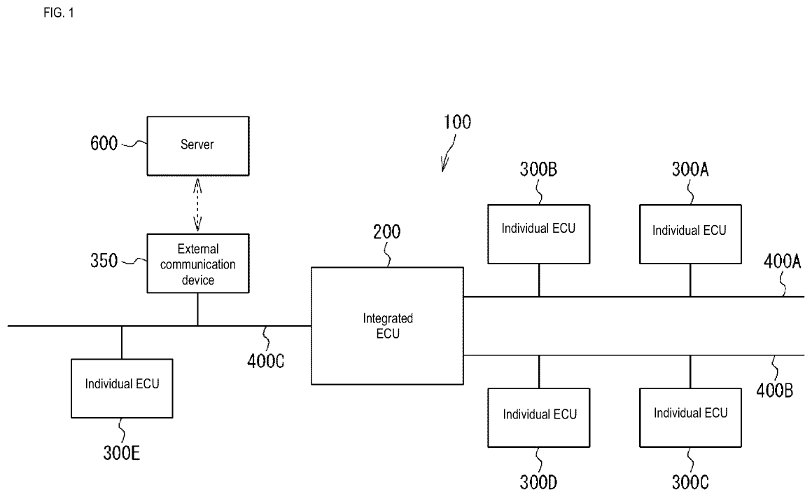

FIG. 1 is a block diagram showing an example of a configuration of a vehicle-mounted system according to this embodiment. The vehicle-mounted system 100 is mounted in a vehicle.

The vehicle-mounted system 100 according to the present embodiment includes an integrated ECU 200 and individual ECUs 300A, 300B, 300C, 300D, and 300E. The vehicle-mounted system 100 is a vehicle-mounted network constituted by the integrated ECU 200, the individual ECUs 300A, 300B, 300C, 300D, and 300E, and communication cables (communication buses) connecting them.

The plurality of individual ECUs 300A, 300B, 300C, 300D, and 300E are arranged in various parts of the vehicle. The individual ECUs 300A, 300B, 300C, 300D, and 300E individually control the hardware of each part of the vehicle and monitor the state of the hardware of each part of the vehicle. For example, the individual ECUs 300A, 300B, 300C, 300D, and 300E are ECUs for a control system, a body system, and an information system. The individual ECUs 300A, 300B, 300C, 300D, and 300E are examples of “vehicle-mounted devices”. Note that in the following description, the individual ECUs 300A, 300B, 300C, 300D, and 300E are also collectively referred to as “individual ECUs 300”.

The integrated ECU 200 is connected to each of the individual ECUs 300A, 300B, 300C, 300D, and 300E via vehicle-mounted buses 400A, 400B, and 400C, such as CAN (Controller Area Network) buses. Specifically, the individual ECUs 300A and 300B are connected to the bus 400A. The individual ECUs 300C and 300D are connected to the bus 400B. The individual ECU 300E is connected to the bus 400C. The integrated ECU 200 can mutually communicate with each of the individual ECUs 300A, 300B, 300C, 300D, and 300E.

The integrated ECU 200 and the individual ECUs 300 use a communication protocol for cyclically transmitting and receiving messages. The communication protocol is, for example, CAN or CAN FD (CAN with Flexible Data Rate).

The integrated ECU 200 has the function of a gateway that relays communication between the plurality of individual ECUs 300. The individual ECUs 300 can transmit messages. The integrated ECU 200 relays messages between the individual ECUs connected to the different buses. For example, the integrated ECU 200 can relay messages between the individual ECU 300A connected to the bus 400A and the individual ECU 300C connected to the bus 400B.

The integrated ECU 200 is connected to an external communication device 350 via the bus 400C. The external communication device 350 is, for example, a wireless communication terminal conforming to 5G or 4G, and is, for example, a TCU (Telematics Control Unit). The external communication device 350 can communicate with a server 600. The external communication device 350 relays communication between the integrated ECU 200 and the server 600.

### Configuration of Integrated ECU

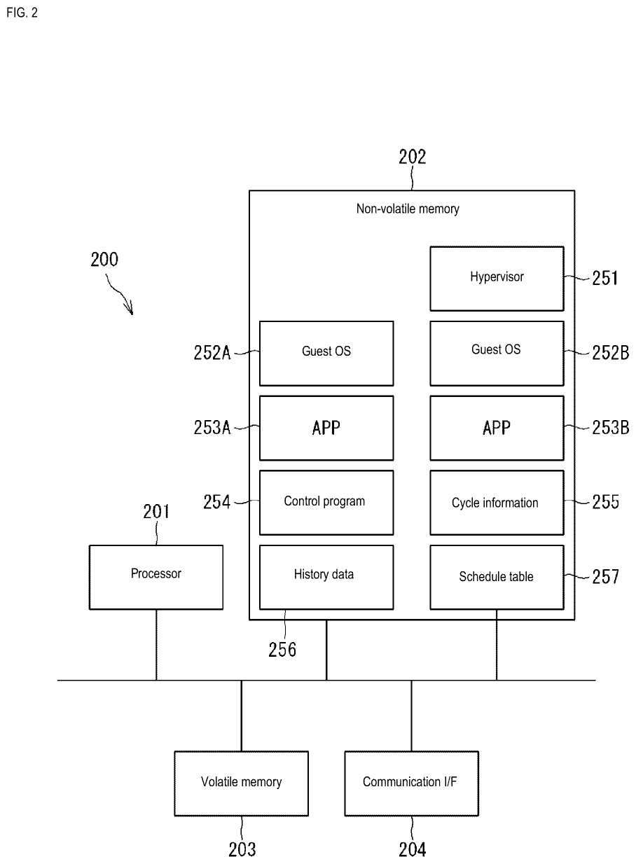

FIG. 2 is a block diagram showing an example of the configuration of the integrated ECU according to this embodiment. The integrated ECU 200 includes a processor 201, a non-volatile memory 202, a volatile memory 203, and a communication interface (I/F) 204.

The volatile memory 203 is, for example, a semiconductor memory such as an SRAM (Static Random Access Memory) or a DRAM (Dynamic Random Access Memory). The non-volatile memory 202 is, for example, a flash memory, a hard disk, or the like. The non-volatile memory 202 is capable of reading and writing data.

The processor 201 is, for example, a CPU (Central Processing Unit). However, the processor 201 is not limited to a CPU. The processor 201 may also be a GPU (Graphics Processing Unit). The processor 201 is configured to be able to execute a computer program. However, the processor 201 may include, for example, an ASIC (Application Specific Integrated Circuit) in a portion thereof, or a programmable logic device such as an FPGA (Field Programmable Gate Array) in a portion thereof.

The communication I/F 204 is a communication interface that complies with the above-mentioned communication protocol for the vehicle-mounted network. The communication I/F 204 includes a plurality of communication ports, and is connected to each of the buses 400A, 400B, and 400C. The communication I/F 204 is connected to each of the individual ECUs 300A, 300B, 300C, 300D, and 300E via the buses 400A, 400B, and 400C. The integrated ECU 200 can communicate with the individual ECUs 300A, 300B, 300C, 300D, and 300E via the communication I/F 204. Furthermore, the integrated ECU 200 can communicate with the server 600 via the external communication device 350 through the communication I/F 204.

A hypervisor 251, guest OSs (Operating Systems) 252A and 252B, and applications (APPs) 253A and 253B are installed in the non-volatile memory 202. The hypervisor 251 is executed by the processor 201 and causes the integrated ECU 200 to function as a virtual machine.

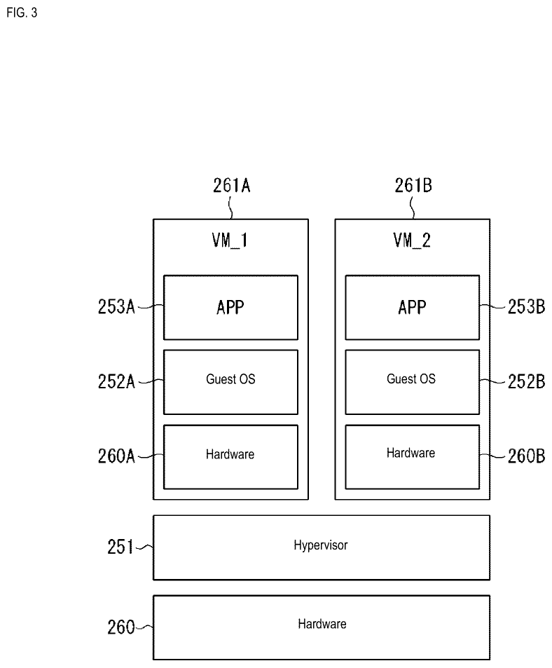

FIG. 3 is a schematic diagram for describing a virtual environment in the integrated ECU according to the present embodiment. The hypervisor 251 operates on hardware 260 (the processor 201, the non-volatile memory 202, the volatile memory 203, the communication I/F 204, etc.). The hypervisor 251 can emulate virtual hardware (HW) 260A and 260B. A virtual machine 261A is realized by emulating the virtual HW 260A, and a virtual machine 261B is realized by emulating the virtual HW 260B. Hereinafter, the virtual machine 261A is also referred to as “VM_1”, and the virtual machine 261B is also referred to as “VM_2”. The VM_1 is an example of a “first processing unit”, and the VM_2 is an example of a “second processing unit”.

The guest OS 252A operates in the VM_1. In the VM_1, the APP 253A operates on the guest OS 252A. The guest OS 252B operates in the VM_2. In the VM_2, the APP 253B operates on the guest OS 252B. The APP 253A is software for realizing the function of a gateway. Due to the processor 201 executing the APP 253A, the integrated ECU 200 can execute relay processing for relaying messages between the individual ECUs 300. The APP 253B is software for realizing a function other than the function of a gateway. The APP 253B is, for example, power window control software. The processor 201 executes the APP 253B, thereby enabling the integrated ECU 200 to control a power window.

The hypervisor 251 manages the execution periods of the VM_1 and the VM_2. The execution periods of the VM_1 and the VM_2 are allocated in a time-sharing manner. The execution period of the VM_1 is a “first period”, and the execution period of the VM_2 is a “second period”.

Returning to FIG. 2, the non-volatile memory 202 stores a control program 254, which is a computer program, as well as cycle information 255, history data 256, and a schedule table 257, which are to be used in the control program 254.

The control program 254 is a program for determining the execution periods of the VM_1 and the VM_2.

The cycle information 255 is information indicating a message transmission cycle of each of the individual ECUs 300A, 300B, 300C, 300D, and 300E. At least some of the individual ECUs 300A, 300B, 300C, 300D, and 300E may have different message transmission cycles. The message transmission cycle may be the same in at least some of the individual ECUs 300A, 300B, 300C, 300D, and 300E. For example, the message transmission cycle of the individual ECU 300A is T1 seconds, and the message transmission cycle of the individual ECU 300B is T2 seconds. The cycle information 255 includes a message transmission cycle for each of the individual ECUs 300. Hereinafter, the message transmission cycle is also referred to as an “individual cycle”.

The history data 256 is a reception history of messages that the integrated ECU 200 has received from the individual ECUs 300. The history data 256 includes identification information of the individual ECU 300 that is the transmission source and the reception time of the message.

The schedule table 257 is a table for defining a first period and a second period. The schedule table 257 stores the first period and the second period determined by the control program 254. The hypervisor 251 operates the VM_1 and the VM_2 in accordance with the first period and the second period designated in the schedule table 257.

### Functions of Integrated ECU

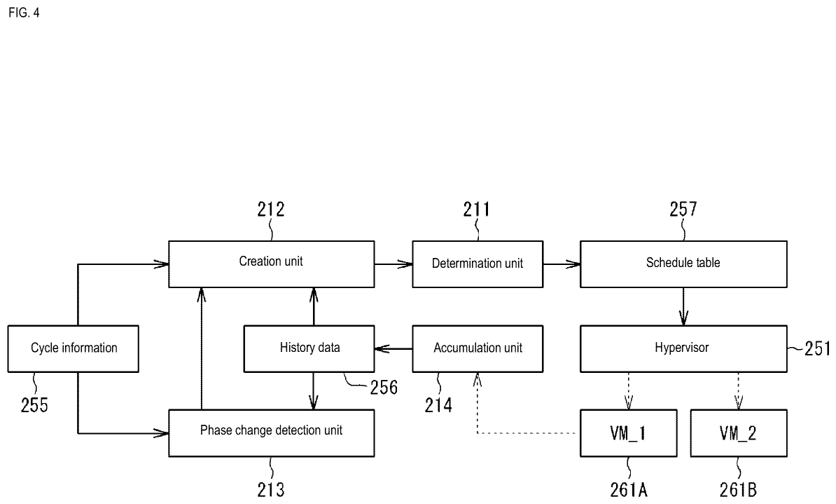

FIG. 4 is a functional block diagram showing an example of functions of the integrated ECU according to the present embodiment.

When the processor 201 executes the control program 254, the functions of a determination unit 211, a creation unit 212, a phase change detection unit 213, and an accumulation unit 214 are realized.

The determination unit 211 dynamically determines a first period for executing the relay processing to be executed by the VM_1 and a second period for executing the processing to be executed by the VM_2. The determination unit 211 determines the first period based on the transmission cycles of messages from the individual ECUs 300.

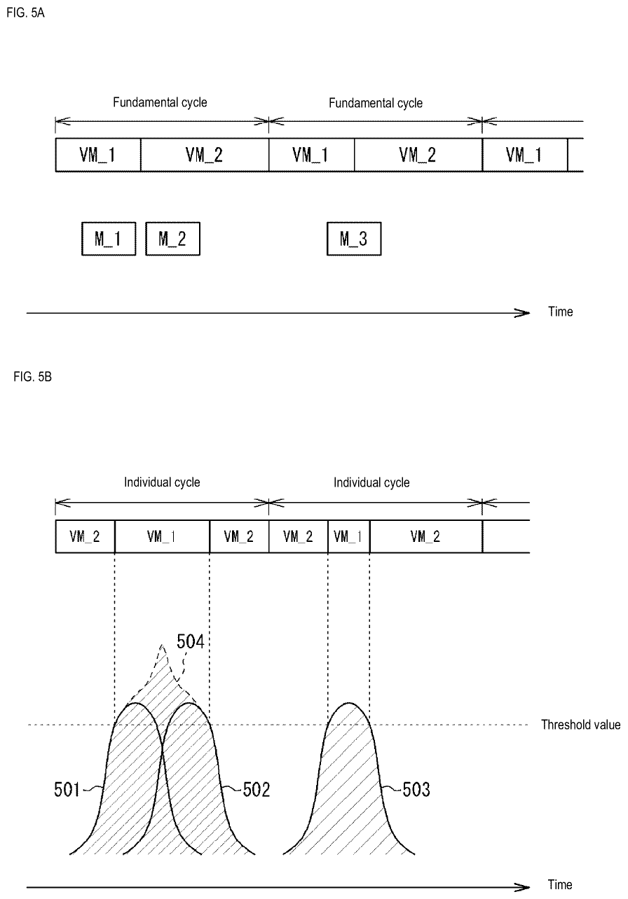

FIG. 5A is a timing chart showing an example of a relationship between the first period, the second period, and the reception timing of messages. In the communication protocol used in the vehicle-mounted system 100, messages are cyclically transmitted from the individual ECUs 300. In the example of FIG. 5A, a message transmitted from the individual ECU 300A is indicated by “M_1”, a message transmitted from the individual ECU 300B is indicated by “M_2”, a message transmitted from the individual ECU 300C is indicated by “M_3”, the first period is indicated by “VM_1”, and the second period is indicated by “VM_2”.

The first period and the second period are designated within a fundamental cycle. FIG. 5A shows an example in which the first period and the second period are determined in a fixed manner in the fundamental cycle. That is, in the example of FIG. 5A, the first period and the second period do not vary in each fundamental cycle. In this case, the messages M_1, M_2, and M_3 are not necessarily received by the integrated ECU 200 during the first period. In the example of FIG. 5A, since the message M_1 is received in the first period, the VM_1 can perform relay processing of the message M_1 in the first period. However, since the messages M_2 and M_3 are not received during the first period, the integrated ECU 200 needs to wait for the next first period to relay the messages M_2 and M_3.

The integrated ECU 200 according to the present embodiment determines the first period in accordance with the transmission cycle of messages from the individual ECUs 300. For this reason, in the integrated ECU 200, the messages M_1, M_2, and M_3 are received in the first period, and the relay processing is efficiently performed.

Returning to FIG. 4, specifically, the determination unit 211 determines the first period based on probability distributions of receiving messages over time (hereinafter referred to as a “reception probability distributions”). The creation unit 212 creates the reception probability distributions.

The creation unit 212 creates the reception probability distributions using the cycle information 255 and the history data 256. FIG. 5B is a diagram for describing the determination of the first period and the second period by the integrated ECU according to the present embodiment. The lower graph in FIG. 5B shows the reception probability distributions. In FIG. 5B, reference sign 501 denotes a reception probability distribution of the message M_1 from the individual ECU 300A, reference sign 502 denotes a reception probability distribution of the message M_2 from the individual ECU 300B, and reference sign 503 denotes a reception probability distribution of the message M_3 from the individual ECU 300C. Although the individual ECUs 300 transmit messages in set individual cycles, the transmission timings of the messages may shift due to communication arbitration or the like when messages are transmitted simultaneously from a plurality of individual ECUs 300. The creation unit 212 creates the reception probability distribution 501 of the message M_1 by using the individual cycle of the individual ECU 300A and the reception history of the message M_1 from the individual ECU 300A. The creation unit 212 creates the reception probability distribution 502 of the message M_2 by using the individual cycle of the individual ECU 300B and the reception history of the message M_2 from the individual ECU 300B. The creation unit 212 creates the reception probability distribution 503 of the message M_3 by using the individual cycle of the individual ECU 300C and the reception history of the message M_3 from the individual ECU 300C.

Returning to FIG. 4, the phase change detection unit 213 detects a change in the phase of the cyclical communication of the messages. In a specific example, the phase change detection unit 213 uses the cycle information 255 and the history data 256 to detect a phase change in the communication of the messages.

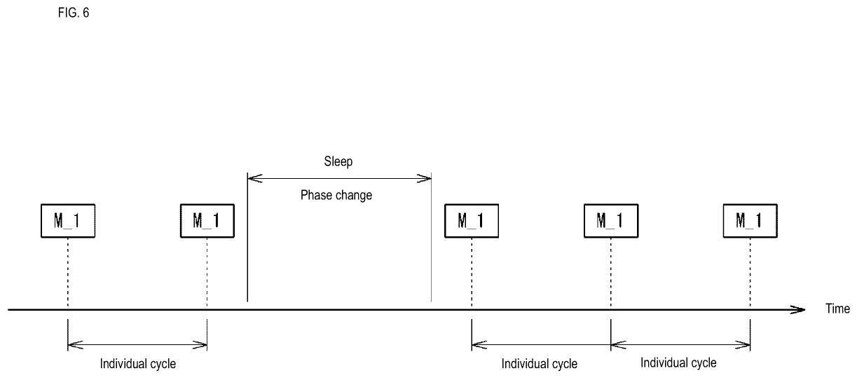

FIG. 6 is a diagram for describing an example of detection of a phase change in message communication. In FIG. 6, the deviation in message transmission timing due to communication arbitration is not taken into consideration. A message M_1 is transmitted from the individual ECU 300A in each individual cycle. In the individual ECUs 300, an event may occur that changes the phase of message transmission. For example, when the individual ECU 300A enters a sleep state, the individual ECU 300A stops transmitting the message M_1. When the individual ECU 300A returns from the sleep state to a normal running state, the cyclical transmission of the message M_1 is resumed, but the phase of the transmission of the message M_1 changes from before the sleep state. The phase change detection unit 213 specifies, for example, a past reception state of the message M_1 in the integrated ECU 200 from the cycle information 255 and the history data 256 and detects a phase change in the reception of the message M_1. The phase change detection unit 213 may detect a phase change in the reception of the message M_1 by monitoring the state (normal running state, sleep state) of the individual ECU 300A.

Returning to FIG. 4, the creation unit 212 creates a reception probability distribution based on the reception history of messages after the phase change detected by the phase change detection unit 213. In the example of FIG. 6, the phase change detection unit 213 detects that a phase change occurs at the end time of a sleep period of the individual ECU 300A (hereinafter referred to as a “phase change point”). The creation unit 212 acquires the reception history of the message M_1 starting from the phase change point from the history data 256 and creates a reception probability distribution of the message M_1 using the acquired reception history. Accordingly, a reception probability distribution of the message M_1 starting from the phase change point is created.

If a plurality of phase changes are detected in the message reception history from one individual ECU 300, the message reception history starting from the last phase change point is used. This makes it possible to obtain a reception probability distribution that accurately reflects the current phase of message reception.

In one example, the creation unit 212 composites a plurality of reception probability distributions. Returning to FIG. 5B, the reception probability distribution 501 of the message M_1 and the reception probability distribution 502 of the message M_2 are composited to create a composite probability distribution 504. More specifically, the creation unit 212 adds the values of the reception probability distributions 501 and 502 for each time to create the composite probability distribution 504.

The determination unit 211 determines the first period based on a comparison between the reception probability distribution created by the creation unit 212 and a threshold value. In the integrated ECU 200, a threshold value (indicated by a dashed line in the drawing) of the message reception probability is set. The determination unit 211 compares the composite probability distribution 504 and the reception probability distribution 503 with the threshold value, and determines a period in which the reception probability is greater than or equal to the threshold value as the first period. For example, the determination unit 211 determines the period other than the first period in the fundamental cycle as the second period.

Returning to FIG. 4, the creation unit 212 creates a reception probability distribution at a timing based on the fundamental cycle, and the determination unit 211 determines the first period and the second period at a timing based on the fundamental cycle. In a specific example, at the timing when the fundamental cycle starts, the creation unit 212 creates a reception probability distribution based on the reception history obtained from a phase detection point up to the current fundamental cycle. The determination unit 211 uses the reception probability distribution created by the creation unit 212 to determine the first period and the second period in the next fundamental cycle. Note that the creation unit 212 does not need to create a reception probability distribution for each fundamental cycle, and the determination unit 211 does not need to determine the first period and the second period for each fundamental cycle. For example, the creation unit 212 may create a reception probability distribution and the determination unit 211 may determine the first period and the second period every predetermined number of fundamental cycles (for example, every three fundamental cycles).

The determination unit 211 stores the determined first period and second period in the schedule table 257. Accordingly, the schedule table 257 is updated. The hypervisor 251 operates the VM_1 and the VM_2 according to the first period and the second period designated in the schedule table 257. This allows the VM_1 to execute relay processing during a period when the message reception probability is high.

The accumulation unit 214 accumulates the message reception history of the integrated ECU 200. The accumulation unit 214 records the identification information of the transmission source of the message and the reception time of the message in the history data 256 every time a message is relayed by the VM_1. This adds new information to the history data 256.

### Operations of Integrated ECU

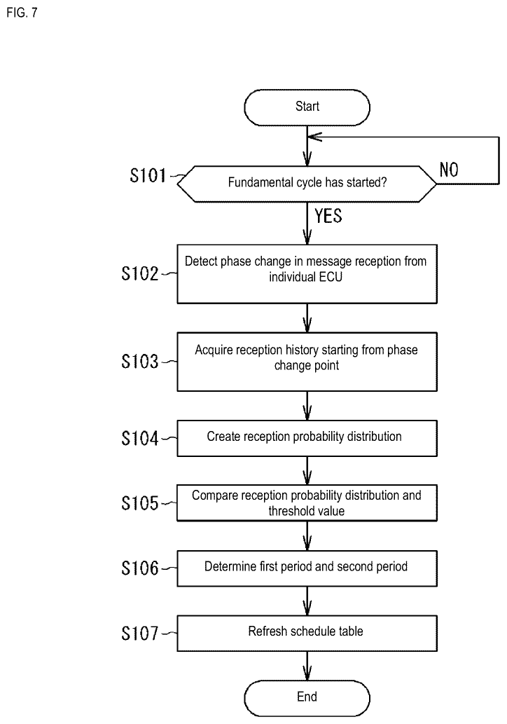

The operations of the integrated ECU according to this embodiment will be described below. The processor 201 of the integrated ECU 200 executes the control program 254 to execute period determination processing as described below. FIG. 7 is a flowchart showing an example of period determination processing performed by the integrated ECU according to the present embodiment.

When the period determination processing starts, the processor 201 determines whether or not a fundamental cycle has started (step S101). If the fundamental cycle has not started (NO in step S101), the processor 201 executes step S101 again.

If the fundamental cycle has started (YES in step S101), the processor 201 refers to the cycle information 255 and the history data 256, and detects a phase change in the reception of a message from an individual ECU 300 (step S102). The processor 201 acquires the reception history starting from the phase change point from the history data 256 (step S103).

The processor 201 creates a message reception probability distribution based on the cycle information 255 and the reception history starting from the phase change point (step S104). If a plurality of reception probability distributions overlap with each other, the processor 201 composites the plurality of reception probability distributions to create a composite probability distribution.

The processor 201 compares the reception probability distribution with a threshold value (step S105) and specifies a period during which the reception probability is greater than or equal to the threshold value. The processor 201 determines the specified period as the first period and determines the period other than the first period in the fundamental cycle as the second period (step S106).

The processor 201 stores the determined first period and second period in the schedule table 257 and updates the schedule table 257 (step S107). This completes the period determination processing.

### Modified Examples

In the above embodiment, when there is overlap between a plurality of reception probability distributions, a composite probability distribution is generated by compositing the reception probability distributions, and the first period is determined by comparing the composite probability distribution with a threshold value. However, there is no limitation thereto. For example, the determination unit 211 may compare the reception probability distribution with a threshold value to specify a period during which the reception probability is greater than or equal to the threshold value, and if two or more periods are specified and the length of a blank period (a period during which the reception probability is less than the threshold value) between adjacent periods is less than or equal to a predetermined value, a period including the adjacent periods and the blank period may be determined as the first period.

In the above embodiment, the first period is determined based on the message reception probability distribution in the integrated ECU 200, but there is no limitation thereto. The first period may also be determined based on the cycle of the messages without using the reception probability distribution. For example, the determination unit 211 can estimate the next message reception time based on the message transmission cycle of the individual ECU 300 designated in the cycle information 255, and determine a period of a predetermined width centered on the estimated message reception time as the first period.

In the above embodiment, the creation unit 212 included in the integrated ECU 200 creates the message reception probability distribution, but there is no limitation thereto. The server 600 may have a function equivalent to that of the creation unit 212 and create the message reception probability distribution. In this case, the integrated ECU 200 can acquire the reception probability distribution from the server through communication, and determine the first period and the second period using the acquired reception probability distribution.

In the above embodiment, the determination unit 211 determines the first period and the second period at a timing based on the fundamental cycle, but there is no limitation thereto. For example, the determination unit 211 may determine the first period and the second period when a change in the state of the vehicle is detected.

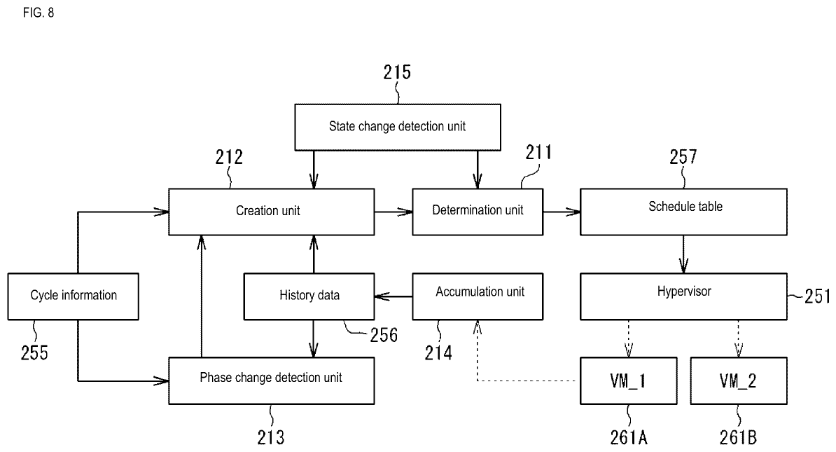

FIG. 8 is a functional block diagram showing a modified example of the functions of the integrated ECU according to the embodiment. The integrated ECU 200 according to this modified example has the function of a state change detection unit 215. The state change detection unit 215 detects a change in the state of the vehicle. When the state change detection unit 215 detects a change in the state of the vehicle, the creation unit 212 creates a message reception probability distribution. When the state change detection unit 215 detects a change in the state of the vehicle, the determination unit 211 determines the first period and the second period based on the reception probability distribution.

For example, the change in the state of the vehicle detected by the state change detection unit 215 may be a change in the traveling state of the vehicle. The state change detection unit 215 acquires, for example, a measurement value of the vehicle speed from a speed sensor, and determines whether the vehicle is traveling or stopped based on the vehicle speed. The state change detection unit 215 detects a change in the vehicle from a traveling state to a stopped state, or from a stopped state to a traveling state. If the state change detection unit 215 detects a change in the traveling state of the vehicle, the creation unit 212 creates a reception probability distribution, and the determination unit 211 determines the first period and the second period based on the reception probability distribution.

For example, the change in the state of the vehicle detected by the state change detection unit 215 can be a change in the configuration of the vehicle-mounted network. The state change detection unit 215 detects the connection of a new individual ECU 300 to the vehicle-mounted network and detects the removal of an individual ECU 300 from the vehicle-mounted network. If the state change detection unit 215 detects a change in the configuration of the vehicle-mounted network, the creation unit 212 creates a reception probability distribution, and the determination unit 211 determines the first period and the second period based on the reception probability distribution.

For example, the change in the state of the vehicle detected by the state change detection unit 215 may be a switch between a normal running state and a sleep state in at least one individual ECU 300. The state change detection unit 215 detects that the individual ECU 300 has switched from the normal running state to the sleep state, and detects that the individual ECU 300 has switched from the sleep state to the normal running state. In a specific example, one individual ECU 300 (e.g., the individual ECU 300E) is a power source management ECU that manages the power sources of the individual ECUs 300A, 300B, 300C, and 300D, and the power source management ECU manages switching between the normal running state and the sleep state of the individual ECUs 300A, 300B, 300C, and 300D. If a switch occurs between the normal running state and the sleep state in an individual ECU 300, the power source management ECU notifies the integrated ECU 200 that switching has occurred between the normal running state and the sleep state in the individual ECU 300, and notifies the integrated 200 of the identification information of the individual ECU 300. When the state change detection unit 215 receives this notification, the state change detection unit 215 detects that switching has occurred between the normal running state and the sleep state in the individual ECU 300. When the state change detection unit 215 detects switching between the normal running state and the sleep state in the individual ECU 300, the creation unit 212 creates a reception probability distribution and the determination unit 211 determines the first period and the second period based on the reception probability distribution.

In the above embodiment, a configuration has been described in which the hypervisor-type virtual machines 261A and 261B execute relay processing and processing different from the relay processing (power window control processing), but there is no limitation thereto. The relay processing and the processing different from the relay processing may be executed by two container-type virtual machines, or the relay processing and the processing different from the relay processing may be executed by two applications operating on a shared OS rather than by virtual machines.

### Effects of the Embodiment

The integrated ECU 200 includes a virtual machine 261A (first processing unit), a virtual machine 261B (second processing unit), and a determination unit 211. The virtual machine 261A executes relay processing for relaying messages to be communicated between the plurality of individual ECUs 300. The virtual machine 261B executes vehicle-related processing different from the relay processing. The determination unit 211 dynamically determines a first period for executing the relay processing to be executed by the virtual machine 261A and a second period for executing the processing to be executed by the virtual machine 261B. This makes it possible to appropriately determine the first period for executing the relay processing and the second period for executing the processing different from the relay processing.

The messages may be cyclically communicated between the plurality of individual ECUs 300. The determination unit 211 may determine the first period based on the cycles of the messages. This makes it possible to allocate the first period to a period during which messages can be received.

The determination unit 211 may determine the first period based on a message reception probability distribution over time. This makes it possible to allocate the first period to a period during which the probability of receiving a message is high.

The determination unit 211 may determine the first period based on a comparison between the reception probability distribution and a threshold value. This makes it possible to use a threshold value to determine a period during which the probability of receiving a message is high.

The integrated ECU 200 may include a creation unit 212. The creation unit 212 creates a reception probability distribution. This makes it possible to determine the first period by using the reception probability distribution created in the integrated ECU 200.

The creation unit 212 may create the reception probability distribution based on a message reception history in the integrated ECU 200. This makes it possible to use the message reception history to obtain a probability distribution that reflects the message reception cycle.

The integrated ECU 200 may include a phase change detection unit 213. The phase change detection unit 213 detects a change in the phase of the cyclical communication of messages. The creation unit 212 may create a reception probability distribution based on the message reception history starting from the phase change point detected by the phase change detection unit 213. This makes it possible to obtain a probability distribution that reflects the message reception cycle starting from the phase change point of the communication.

The determination unit 211 may determine the first period based on a reception probability distribution created by a server 600 (external device) provided outside the vehicle. This eliminates the need to create a reception probability distribution in the integrated ECU 200. The integrated ECU 200 can determine the first period by using the reception probability distribution created in the server 600.

The determination unit 211 may determine the first period and the second period at a timing based on a fundamental cycle (a fixed cycle) that includes the first period and the second period. This makes it possible to determine the first period and the second period at an appropriate timing.

The integrated ECU 200 may include a state change detection unit 215. The state change detection unit 215 detects a change in the state of the vehicle. The determination unit 211 may determine the first period and the second period when the state change detection unit 215 detects a change in the state of the vehicle. This makes it possible to determine the first period and the second period at an appropriate timing.

The change in the state of the vehicle may include a change in the traveling state of the vehicle. This makes it possible to determine the first period and the second period at the timing when the traveling state of the vehicle changes.

The change in the state of the vehicle may include a change in the configuration of the vehicle-mounted network that includes the plurality of individual ECUs 300. This makes it possible to determine the first period and the second period at the timing when the configuration of the vehicle-mounted network changes.

The change in the state of the vehicle may include at least one of the plurality of individual ECUs 300 switching from a normal running state to a sleep state, or from the sleep state to the normal running state. This makes it possible to determine the first period and the second period at the timing when the state of the individual ECU 300 changes between the normal running state and the sleep state.

### APPENDIX

The embodiments disclosed herein are illustrative in all respects and are not restrictive. The scope of the present disclosure is defined not by the above-described embodiments but by the claims, and all modifications within the meaning and scope equivalent to the claims are encompassed therein.

1. A vehicle-mounted control device comprising:
a first processing unit configured to execute relay processing for relaying a message to be communicated between a plurality of vehicle-mounted devices;
a second processing unit configured to execute vehicle-related processing different from the relay processing; and
a determination unit configured to dynamically determine a first period for executing the relay processing to be executed by the first processing unit and a second period for executing the processing to be executed by the second processing unit.

2. The vehicle-mounted control device according to claim 1,
wherein the message is cyclically communicated between the plurality of vehicle-mounted devices, and
the determination unit determines the first period based on a cycle of the message.

3. The vehicle-mounted control device according to claim 2,
wherein the determination unit determines the first period based on a probability distribution of receiving the message over time.

4. The vehicle-mounted control device according to claim 3,
wherein the determination unit determines the first period based on a comparison between the probability distribution and a threshold value.

5. The vehicle-mounted control device according to claim 3, further comprising
a creation unit configured to create the probability distribution.

6. The vehicle-mounted control device according to claim 5,
wherein the creation unit creates the probability distribution based on a reception history of the message in the vehicle-mounted control device.

7. The vehicle-mounted control device according to claim 6, further comprising
a phase change detection unit configured to detect a change in a phase of cyclical communication of the message,
wherein the creation unit creates the probability distribution based on the reception history of the message after the change in the phase detected by the phase change detection unit.

8. The vehicle-mounted control device according to claim 3,
wherein the determination unit determines the first period based on the probability distribution created by an external device provided outside of the vehicle.

9. The vehicle-mounted control device according to claim 1,
wherein the determination unit determines the first period and the second period at a timing based on a fixed cycle including the first period and the second period.

10. The vehicle-mounted control device according to claim 1, further comprising
a state change detection unit configured to detect a change in a state of the vehicle,
wherein the determination unit determines the first period and the second period when a change in the state is detected by the state change detection unit.

11. The vehicle-mounted control device according to claim 10,
wherein the change in the state of the vehicle includes a change in a traveling state of the vehicle.

12. The vehicle-mounted control device according to claim 10,
wherein the change in the state of the vehicle includes a change in a configuration of a vehicle-mounted network including the plurality of vehicle-mounted devices.

13. The vehicle-mounted control device according to claim 10,
wherein the change in the state of the vehicle includes at least one of the plurality of vehicle-mounted devices switching from a normal running state to a sleep state, or from the sleep state to the normal running state.

14. A control method comprising:
a step of executing relay processing for relaying a message to be communicated between a plurality of vehicle-mounted devices;
a step of executing vehicle-related processing different from the relay processing; and
a step of dynamically determining a first period for executing the relay processing and a second period for executing the processing different from the relay processing.

15. A control program to be used in a vehicle-mounted control device configured to execute relay processing for relaying a message to be communicated between a plurality of vehicle-mounted devices and vehicle-related processing different from the relay processing, the control program being for causing a computer to function as a determination unit configured to dynamically determine a first period for executing the relay processing and a second period for executing the processing different from the relay processing.
